(19) United States
(12) Patent Application Publication
(10) Pub. No.: US 2018/0259651 A1
(43) Pub. Date: Sep. 13, 2018

(54) METHOD AND APPARATUS FOR ASSESSING A POSITION OF A VEHICLE

(71) Applicants: Continental Teves AG & Co. oHG, Frankfurt (DE); Continental Automotive GmbH, Hannover (DE)

(72) Inventors: Henrik Antoni, Freigericht (DE); Ulrich Stählin, Oakland Township, MI (US); Michael Zalewski, Frankfurt am Main (DE); Sandro Syguda, Friedrichsdorf (DE); Pierre Blüher, Hattersheim, MI (US); Holger Faisst, Sinzing (DE)

(73) Assignees: Continental Teves AG & Co. oHG, Frankfurt (DE); Continental Automotive GmbH, Hannover (DE)

(21) Appl. No.: 15/977,439

(22) Filed: May 11, 2018

Related U.S. Application Data
(63) Continuation of application No. PCT/DE2016/200515, filed on Nov. 10, 2016.

(30) Foreign Application Priority Data
Nov. 12, 2015 (DE) 10 2015 222 355.8
Jan. 2, 2016 (DE) 10 2016 201 487.0

(51) Int. Cl. G01S 19/42; G01S 19/20; G01S 19/41; G01S 19/47; G01S 19/22; G01S 19/35

(52) U.S. Cl. CPC G01S 19/426; G01S 19/20; G01S 19/35; G01S 19/47; G01S 19/22; G01S 19/41

(57) ABSTRACT

A method and an apparatus for assessing a position of a vehicle are described herein. The disclosure proposes ascertaining a first absolute position utilizing a conventional GNSS receiver. This is to be compared with a second absolute position, which is ascertained in a secure safety unit or a secure ASIL-compatible chip, and is therefore always plausible.

### CROSS REFERENCE TO RELATED APPLICATION

This application is a continuation of International application No. PCT/DE2016/200515, filed Nov. 10, 2016, which claims priority to German patent application Nos. 10 2015 222 355.8, filed Nov. 12, 2015, and 10 2016 201 487.0, filed Feb. 1, 2016, each of which is hereby incorporated by reference.

### TECHNICAL FIELD

The technical field relates to determining a position of a vehicle.

### BACKGROUND

Global navigation satellite systems, such as GPS, Galileo, etc., are state of the art. They are used in today's vehicles to ascertain the position of the vehicle absolutely in a global system of coordinates. The positions are nowadays used inter alia for carrying out navigation of the vehicle.

With the increase in automated driver assistance systems and plans for autonomous driving of the vehicle, the accuracy of the positional data takes on greater importance. To be able to autonomously drive the vehicle safely, ascertainment of the position of the vehicle with an accuracy greater than that of today's systems is required. Apart from greater accuracy, it must be ensured at all times that the ascertainment of the position of the vehicle complies with functional safety, in order to ascertain and select only positions presumed to be correctly ascertained. This is so because interventions by a driver assistance system on the basis of a false position may have fatal consequences. Systems that achieve both great accuracy and functional safety are known from modern aviation. However, they are much too large and expensive for use in vehicles such as for example conventional automobiles or motorcycles.

As such, it is desirable to present a method and/or an apparatus with which an assessment of the ascertained position can be safely carried out. In addition, other desirable features and characteristics will become apparent from the subsequent summary and detailed description, and the appended claims, taken in conjunction with the accompanying drawings and this background.

### SUMMARY

According to a first aspect, a method for assessing a position of a vehicle, in particular an autonomously driven vehicle, utilizes an apparatus for ascertaining a position of a vehicle. The apparatus includes an antenna for receiving satellite navigation data of a global satellite navigation system (“GNSS”), at least one processing unit for processing the satellite navigation data received and a s safety unit for the secure processing of data. The method includes transmitting a first absolute position, ascertained by a processing unit, to the safety unit. The method also includes receiving satellite navigation data utilizing the safety unit. The method further includes ascertaining a second absolute position on the basis of the satellite navigation data utilizing the safety unit. The method also includes comparing the first absolute position with the second absolute position utilizing the safety unit. The method further includes assessing the first absolute position in dependence on the deviation from the second absolute position or vice versa utilizing the safety unit.

According to the method, a first absolute position is ascertained in a known way utilizing a processing unit or a GNSS receiver. The first processing unit or the GNSS receiver does not have to be especially designed to meet high safety requirements. It is instead possible to rely on processing units or GNSS receivers that are known from the prior art, in particular those that are suitable for use in motor vehicles. It is possible that the first absolute position ascertained by the first processing unit may be affected by errors. To detect and possibly also quantify these errors, a safety unit is provided, which ascertains a second absolute position and creates a basis for comparison for assessing the first absolute position. For a position of the vehicle, consequently, two absolute positions are ascertained in two different, independent ways, the second absolute position being ascertained utilizing a secure safety unit. The protection of the safety unit in this case ensures that the safety unit is not affected by any malfunctions and does not have any undetected faults of failure modes. In this way, it can also be assumed that the second absolute position forms a reliable basis for comparison for the first absolute position.

Ascertaining the second absolute position, comparing the first absolute position with the second absolute position, and assessing the first absolute position may be carried out exclusively in the safety unit. Thus, the expenditure on hardware can be kept down. As an alternative, comparing the first absolute position with the second absolute position may also be carried out on other hardware or another chip.

It is also advantageous that the safety unit relies on the same satellite navigation data that is also used in the processing unit for ascertaining the first absolute position. Thus, the safety unit can also establish at an early time on the basis of the satellite navigation data whether there is an error in the set of data itself or in the processing unit.

It should be noted that the method described herein can also be used for determining a position of a vehicle. The subject matter therefore also includes a method for ascertaining a position, in particular a position checked as plausible, for a vehicle or motor vehicle, in particular an autonomously driven vehicle.

According to one exemplary embodiment of the method, at least the part of the safety unit that ascertains the second absolute position, preferably the entire safety unit, is configured as a safety unit that is secure in terms of software and/or in terms of hardware.

An embodiment of the method in which the safety unit is configured as an independent microcontroller is particularly advantageous.

In addition, an embodiment of the method in which the microcontroller is configured in such a way as to meet the requirements of ASIL A, B, C, or D in accordance with ISO 26262 is particularly preferred. According to the aforementioned embodiments, the safety unit is configured such that it always meets the required safety requirements for the respective applications. In particular, the protection of the safety unit in terms of hardware and in terms of software ensures that the second absolute position is ascertained in conformity with the safety standards that are applicable. It is desirable that the hardware or the chip meets the requirements of a desired ASIL level, i.e., on the one hand offers a sufficiently good probability of failure or high availability, on the other hand does not have any undetected failure modes. Apart from protecting the hardware, this combination achieves a redundancy with respect to the software or firmware used in the sense of an ASIL decomposition.

According to an embodiment of the method, an output of a position takes place exclusively utilizing the safety unit. In this way, it is ensured that the applications that use the positions receive them over a secure channel. It should be noted that the safety unit may also output multiple position outputs simultaneously. It must be decided application-dependently whether the first absolute position is output directly or indirectly after an offsetting against the second absolute position. In addition, it is conceivable to output the second absolute position also in addition to the first absolute position.

According to an embodiment of the method, the safety unit receives merged sensor data or direct sensor data from driving-dynamics sensors, in particular initial sensors, for ascertaining the second absolute position. In this way, the safety unit can ascertain the second absolute position with greater accuracy.

According to an embodiment of the method, the driving-dynamics sensors are designed in such a way as to meet the requirements of ASIL A, B, C or D in accordance with ISO 26262. In this way it is ensured that no malfunctions find their way into the safety unit via the driving-dynamics sensors.

According to an embodiment of the method, the satellite navigation data is transmitted to the safety unit before corrections, in particular of satellite-related, signal-related, atmospheric, or environment-related errors, are applied to the satellite navigation data. This does have the consequence that the safety unit ascertains a second absolute position that is possibly less accurate than the first absolute position. However, in this way it is possible to eliminate any erroneous influencing of the correction data in the ascertainment of the second absolute position. If it is therefore intended to ascertain the second absolute position less accurately but with greater plausibility. If the results of the comparison lie within defined tolerances, a reliable position can be output. The tolerances may be dynamically adapted in accordance with the GNSS accuracy at the time. Correction data should be understood as meaning in particular those data that correct the constant errors due to atmospheric or multipass errors.

According to an embodiment of the method, the position to be output is assigned a measure of safety, in particular on ASIL levels, in dependence on the deviations of the first absolute position ascertained by means of the first processing unit in relation to the second absolute position. The measure of safety differs from a measure of accuracy in that it is an indication of the probability or certainty that the absolute position ascertained is not affected by any error, in particular malfunction. It is therefore proposed to assign two different measures of quality, to be specific a measure of accuracy and in addition also a measure of safety, to the respective positions to be output. In this way, the applications that follow can make use of the positions individually.

According to an embodiment of the method, safety levels, in particular ASIL safety levels, of the software and hardware components used are taken into account for ascertaining the measure of safety.

According to an embodiment of the method, the method includes checking the satellite navigation data utilizing the safety unit. It is proposed here that the safety unit checks the raw data that are used for ascertaining the absolute position for their plausibility. For this purpose, the raw data are brought into relation with one another and checked for whether there is an implausible deviation from one another.

In an embodiment of the method, multiple satellite navigation data are compared with one another or considered in relation to one another, in particular on the basis of the following criteria:
change in distance from a satellite,
relative speeds,
range rates from satellites,
deviation in the signal correlation of different satellite signals.

According to an embodiment of the method, the first processing unit and the safety unit process in each case independently of one another satellite signals for ascertaining the first and second absolute positions. In this way, so-called common cause errors can be avoided. In one embodiment, it is proposed that the first processing unit uses or processes for example satellite signals from GPS satellites and the safety unit uses or processes satellite signals from for example Galileo, Glonass, or Beidou.

According to an embodiment of the method, it is proposed that the satellite navigation data is transmitted to the safety unit utilizing a second processing unit, in particular a second processing unit that is independent of the first processing unit. This embodiment is based on the basic idea that two processing units or GNSS receivers that are independent of one another are used. One of these or the first processing unit is formed completely and is suitable for ascertaining the one or first absolute position. The second processing unit differs from the first processing unit in that it is preferably not designed in the same way as the first processing unit. In this way, on the one hand, system errors in the processing units can be restricted just to the first processing unit or to one of the processing units. In addition, the second processing unit may have a shortened data processing chain for processing the satellite navigation data, so that possible inferences of types of error are more easily identifiable. The shortened data processing chain in the second processing unit also has the advantage that the number of links of the chain that can cause an error is kept as small as possible. Ideally, the second processing unit comprises an RF part for GNSS, including filters and mixers and a correlation unit or a correlator and tracker for the detection of the satellite signals.

According to an embodiment of the method, the satellite navigation data is transmitted to the safety unit before or after corrections, in particular of satellite-related, signal-related, atmospheric or environment-related errors, are applied. In this way, it can be individually established which influence the second processing unit has on the satellite navigation data to be transmitted.

According to an embodiment of the method, the safety unit checks the first absolute position for whether it lies within a range of tolerance in relation to the second absolute position.

According to an embodiment of the method, the position to be output is provided with a flag or a data content if the first absolute position lies outside the range of tolerance. In this way, identification of unsafe positions is ensured.

According to a further aspect, an apparatus for ascertaining a position of a vehicle, in particular for performing a method according to one of the aforementioned embodiments, includes:
an antenna for receiving satellite navigation data of a global satellite navigation system (GNSS),
at least one processing unit for processing the satellite navigation data received, and
also having a secure safety unit for the secure processing of satellite navigation data.

According to an embodiment of the apparatus, the safety unit includes a unit for the secure ascertainment of an absolute position.

According to an embodiment of the apparatus, the safety unit includes a comparison unit for the secure comparison of two absolute positions.

According to an embodiment of the apparatus, the safety unit includes an output unit for the secure output of a position.

According to an embodiment of the apparatus, the apparatus also includes a second processing unit for processing the satellite navigation data received, the second processing unit being independent of the first processing unit and coupled to the safety unit.

The first and second processing units may be configured differently with respect to their software and/or hardware. In one embodiment, the processing units originate from different manufacturers.

In one embodiment, the second processing unit may be minimally equipped, with a high-frequency transducer, analog-digital converter, and a correlation unit for assigning the satellite navigation data to the respective satellites. In this way, on the one hand, costs for the second processing unit can be saved. On the other hand, the chain of possible causes of errors can be kept as small as possible.

According to an embodiment, the apparatus also includes in each case a correction unit for the correction of errors in the satellite navigation data, in particular of satellite-related, signal-related, atmospheric or environment-related errors, for the first and second processing units.

According to an embodiment of the apparatus, at least the part of the safety unit that makes the second absolute position possible, or the entire safety unit, is configured as a safety unit that is secure in terms of software and/or in terms of hardware.

According to an embodiment of the apparatus, the safety unit is configured as an independent microcontroller.

According to a an embodiment of the apparatus, the microcontroller is configured in such a way as to meet the requirements of ASIL A, B, C or D in accordance with ISO 26262.

Also disclosed is a computer program for performing a method according to one of the aforementioned embodiments on an apparatus.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows a block diagram of a first exemplary embodiment of the apparatus for performing the method; and

FIG. 2 shows a block diagram of a second exemplary embodiment of the apparatus for performing the method.

### DETAILED DESCRIPTION

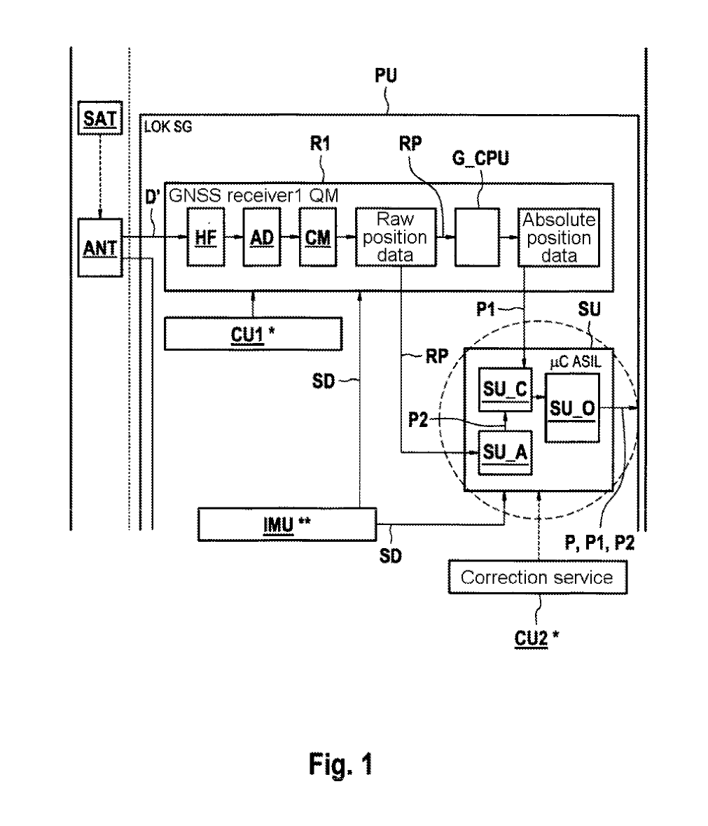

FIG. 1 shows a block diagram of a first exemplary embodiment of the apparatus PU for ascertaining a position of a vehicle. The apparatus PU is preferably fitted in a motor vehicle, e.g., an autonomously driven vehicle. The vehicle is not depicted in the figures. The vehicle also comprises an antenna ANT for receiving satellite data from GNSS satellites SAT.

The apparatus PU includes a first processing unit R1, which receives the satellite data D′ from the antenna ANT. In addition, the apparatus PU has a safety unit SU, which is coupled to the processing unit R1, in order to receive an absolute position P1 from the first processing unit R1. In addition, the apparatus comprises a correction unit CU1, which is coupled to the first processing unit R1. Furthermore, the apparatus PU comprises a sensor unit IMU, which senses sensor data SD in relation to the dynamics of the vehicle. The correction unit CU1 is optional and is advantageous whenever the accuracy or reliability of the first absolute position to be ascertained is to be increased. The sensor unit IMU is also optional and is advantageous whenever a greater availability and accuracy of the absolute positions or absolute position is necessary.

The first processing unit R1 includes multiple functional blocks. The satellite data D′ received by the antenna ANT is preprocessed utilizing a high-frequency filter HF and an analog-digital converter AD. The preprocessed data is then transmitted to a correlation unit or a correlator and tracker CM. The correlation unit CM ensures that the satellite data D′ is assigned to the respective satellites from which they were received. The satellite data D′ processed in this way can then be used as raw data of the satellite navigation data, or the satellite navigation data RP, in order to ascertain an absolute position. In the first processing unit R1, there is for this a software-based or hardware-based processor G_CPU, which ascertains from the raw data or the satellite navigation data RP a first absolute position P1. This is then transmitted to a comparator SU_C of the safety unit SU.

The safety unit SU of this embodiment includes three functional blocks. The safety unit SU includes a software algorithm block SU_A, which ascertains a second absolute position P2 from the raw data of the satellite navigation data RP. The second absolute position P2 is also made available to the comparator SU_C.

Within the comparator SU_C, the first and second absolute positions are compared with one another and checked for plausibility in different ways. The assessment of the first absolute position P1 on the basis of the second absolute position P2 may in this case take place in different ways, as further described hereafter.

An output and assessment unit SU_O of the safety unit SU is configured to mark the position P to be output with a measure of accuracy and/or a measure of safety.

For ascertaining the measure of safety, the raw data of the satellite navigation data RP transmitted to the safety unit SU is not processed by the correction unit CU1. This, however, has no influence on the processing of the satellite navigation data in the first processing unit R1. This data continues to be corrected by means of the correction unit CU1, in order to ascertain an absolute position that is as accurate as possible. In this case, it may be that the second absolute position P2 does not have the same accuracy as the first absolute position P1. However, it is ensured that the second absolute position P2 is plausible. Consequently, the plausibility of the first absolute position P1 can also be ascertained when it lies within a greater range of tolerance in relation to the second absolute position P2. In this way, the first absolute position P1 can be marked with two different measures of quality, to be specific, the measure of accuracy and the measure of safety.

In one embodiment, the position output is in this way differentiated between highly accurate and relevant to safety. Thus, the highly accurate position can be output, including the great accuracy, while for safety applications of the “highly accurate” position an ASIL with associated dynamic safety limit that is obtained inter alia from the corresponding GNSS accuracy and the ASIL comparison. Consequently, an item of position information optimized with respect to accuracy, with an accuracy of, for example, 10 cm, may be output and a secure item of information, with an ASIL (Automotive Safety Integrity Level) to the dynamic safety limit, for example, 7 m, may be output. Following applications can then operate optimally on the basis of the two values and represent precision control combined with secure functions. It can remain open here in which data format these measures of quality, i.e., the measure of accuracy and the measure of safety, are output.

The position ascertaining unit SO_A of the safety unit SU is additionally configured such that it can directly check the plausibility of the satellite navigation data RP. For this purpose, the raw data of the satellite navigation data RP are compared in relation to one another. If it is found that the raw data of the satellite navigation data RP are plausible, a secure second absolute position P2 can subsequently be ascertained. When checking the raw data of the satellite navigation data RP, it is possible to deliberately dispense with taking into account driving-dynamics sensor data of the sensor unit IMU. Checking the raw data of the satellite navigation data RP may for example comprise checking changes of position and variables derived therefrom, changes in distance from the satellite, relative speeds and resultant range rates from the satellite, comparison of the raw signals with one another and use of signal correlations. In this way, the safety unit SU can be used for monitoring the processing unit or the GNSS receivers R1 and nevertheless for generating a secure absolute position.

The apparatus PU may be configured in such a way that the processing unit R1 of the safety unit SU makes available satellite navigation data RP that originate from other types of satellite navigation than those that are used by the first processing unit R1. The independence of the position determination in the GNSS receiver R1 and the safety unit SU is in this way increased further and the probability of common-cause errors is reduced further.

By the described method, a redundancy in the calculation of the absolute position can be achieved with relatively little effort utilizing the available processing units, GNSS receivers, or a GNSS chip with its properties. With a GNSS chip, in particular a chip that does not provide any further protection apart from the quality measures that are customary in the sector, and an ASIL chip for the safety unit SU, in particular a chip developed in accordance with ISO 26262, an ASIL position P can be provided by corresponding monitoring. This makes it possible to dispense with rare and expensive ASIL GNSS chips that are in each case individual systems and developments in small numbers (<1,000 p.a.) and are consequently not suitable for the mass market (>1,000,000 p.a.). There is also no need for GNSS suppliers for the mass market, and consequently the expensive and complex development of special hardware with ASIL functionality for the automobile market, since they often concentrate on quality requirements for smartphones and other mass-produced products without a safety function.

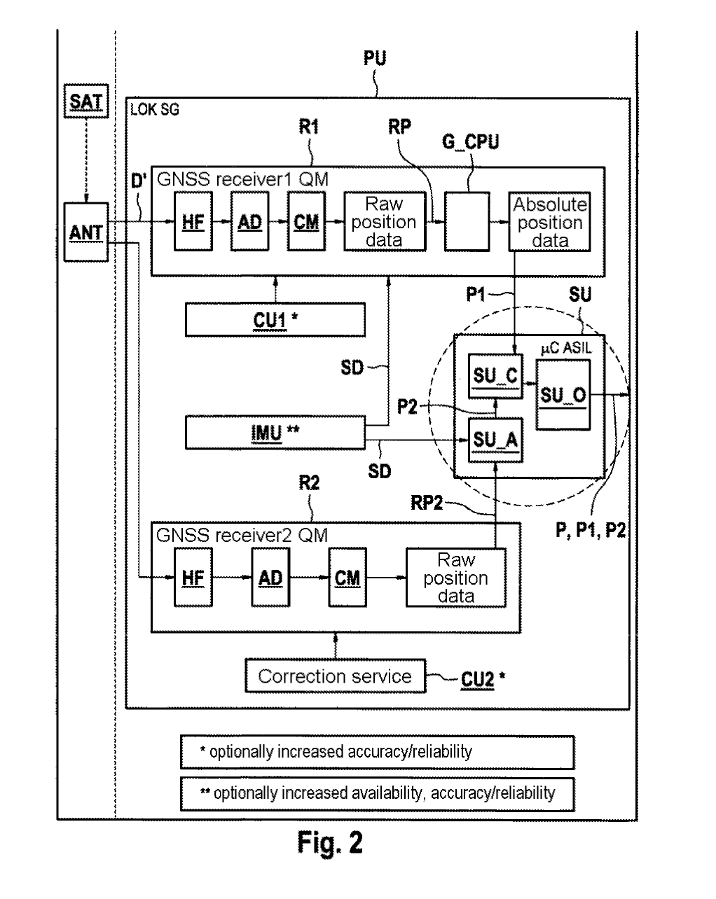

A second exemplary embodiment of the apparatus is depicted in FIG. 2. The second exemplary embodiment differs from the first exemplary embodiment in that it includes a second processing unit R2, which is configured differently from the first processing unit R1. Only in this exemplary embodiment, the second processing unit R2 comprises a high-frequency filter HF, an analog-digital converter AD, and a correlation unit CM. In the second processing unit, only raw data of the satellite navigation data RP2 are then generated independently of the first processing unit R1. These data are then made available to the safety unit SU, so that the second absolute position P2 can be ascertained in the position ascertaining unit SU_A of the safety unit SU.

The position P can then be further used in the vehicle. Depending on the application, multiple outputs by the output and assessment unit SU_O are conceivable. The position P to be output may correspond to the first absolute position. As an alternative, the position P to be output may also correspond to the second absolute position. As a further alternative, the position P to be output may be ascertained from the first and second absolute positions. As an additional alternative, the first and second absolute positions may also be output. If a plausibility check of the absolute position is not possible by way of the comparison, this is indicated in the vehicle by means of a flag.

Among the advantages of the second exemplary embodiment is that, because of the different configuration of the processing units, different sources of error can be reliably detected. Since the satellite navigation data D′ received are processed on two different channels and subsequently processed on the one hand in the first processing unit R1 and in the safety unit to form absolute positions P1, P2, it is possible to compare with one another and identify individual types of error that can occur in the processing units R1, R2. In this way it is ensured that the errors can be identified and correspondingly marked in the apparatus according to the invention.

Both exemplary embodiments are based on the basic idea that the safety unit forms a secure unit that functions faultlessly at all times. In this case, the calculations, comparison and design of hardware and software must take place according to the required safety integrity, for example according to an ASIL level. For this, a microcontroller, designed according to one of the safety levels ASIL A-D in accordance with ISO 26262, may be used. The first and second processing units R1 and R2 then no longer have to be designed as expensive components that likewise conform to the high safety levels. The costs for producing an apparatus can in this way be effectively reduced, without at the same time reducing the safety in the ascertainment of the absolute positions.

Depending on the requirement for the quality and availability of the signal, it is also possible to dispense with the correction services and/or inertial sensors. In this respect, the GNSS receivers can also operate with one or more setup(s) (GPS, Galileo, Glonass, etc.). They do not have to be the same for the positional calculation. Different setups would be an advantageous argument with respect to safety integrity. Operating with different GNSS frequencies is also possible and can provide additional support for a safety argument.

In addition, the absolute position data can also be used for calculating the absolute speeds and accelerations with safety integrity.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method for assessing a position of a vehicle by an apparatus comprising an antenna for receiving satellite navigation data of a global satellite navigation system (GNSS), at least one processing unit for processing the satellite navigation data received, and a safety unit for the secure processing of data, comprising:
transmitting a first absolute position, ascertained by a first processing unit, to the safety unit;
receiving satellite navigation data at the safety unit;
ascertaining a second absolute position on the basis of the satellite navigation data utilizing the safety unit;
comparing the first absolute position with the second absolute position utilizing the safety unit, and
assessing the first absolute position in dependence on the deviation from the second absolute position or vice versa with the safety unit.

2. The method as set forth in claim 1, wherein at least the part of the safety unit that ascertains the second absolute position is secure in terms of software and/or in terms of hardware.

3. The method as set forth in claim 2, wherein the safety unit is an independent microcontroller.

4. The method as set forth in claim 3, wherein the microcontroller meets the requirements of ASIL A, B, C, or D in accordance with ISO 26262.

5. The method as set forth in claim 1, further comprising outputting a position exclusively utilizing the safety unit.

6. The method as set forth in claim 1, further comprising receiving sensor data at the safety unit from at least one inertial sensor for ascertaining the second absolute position.

7. The method as set forth in claim 1, wherein the at least one inertial sensor meets the requirements of ASIL A, B, C, or D in accordance with ISO 26262.

8. The method as set forth in claim 7, further comprising transmitting the satellite navigation data to the safety unit before corrections of satellite-related, signal-related, atmospheric, and environment-related errors are applied to the satellite navigation data.

9. The method as set forth in claim 8, further comprising ascertaining a measure of safety to the position to be output on ASIL levels, in dependence on the deviation of the first absolute position by the first processing unit in relation to the second absolute position.

10. The method as set forth in claim 9, wherein ascertaining the measure of safety includes accounting for ASIL safety levels of the software and hardware components used.

11. The method as set forth in claim 1, further comprising checking the satellite navigation data with the safety unit.

12. The method as claimed in claim 11, checking the satellite navigation data with the safety unit comprises comparing multiple satellite navigation data with one another, wherein the multiple satellite navigation data includes: change in distance from a satellite, relative speeds, range rates from satellites, and deviations in the signal correlation of different satellite signals.

13. The method as set forth in claim 1, wherein the first processing unit and the safety unit process in each case independently of one another satellite signals for ascertaining the first and second absolute positions.

14. The method as set forth in claim 1, further comprising transmitting the satellite navigation data to the safety unit by a second processing unit that is independent of the first processing unit.

15. The method as set forth in claim 14, wherein the transmitting the satellite navigation data occurs before or after corrections of satellite-related, signal-related, atmospheric, and environment-related errors are applied to the satellite navigation data.

16. The method as set forth in claim 14, further comprising checking, utilizing the safety unit, whether the first absolute position lies within a range of tolerance in relation to the second absolute position.

17. The method as set forth in claim 16, further comprising providing a flag or a data content to position to be output is provided if the first absolute position lies outside the range of tolerance.

18. An apparatus for ascertaining a position of a vehicle, comprising:
an antenna for receiving satellite navigation data of a global satellite navigation system (GNSS);
at least one processing unit for processing the satellite navigation data received; and
a safety unit for the secure processing of satellite navigation data.

19. The apparatus as set forth in claim 18, wherein the safety unit comprises a unit for the secure ascertainment of an absolute position.

20. The apparatus as set forth in claim 18, wherein the safety unit comprises a comparison unit for the secure comparison of two absolute positions.

21. The apparatus as set forth in claim 18, wherein the safety unit comprises an output unit for the secure output of the position.

22. The apparatus as set forth in claim 18, further comprising a second processing unit for processing the satellite navigation data received, the second processing unit being independent of the first processing unit and coupled to the safety unit.

23. The apparatus as set forth in claim 22, further comprising two correction units for the correction of satellite-related, signal-related, atmospheric, or environment-related errors in the satellite navigation data, for the first and second processing units respectively.

24. The apparatus as set forth in claim 18, wherein at least the part of the safety unit that ascertains the second absolute position is secure in terms of software and/or in terms of hardware.

25. The apparatus as set forth in claim 18, wherein the safety unit is implemented as an independent microcontroller.

26. The apparatus as set forth in claim 25, wherein the microcontroller is configured to meet the requirements of ASIL A, B, C, or D in accordance with ISO 26262.
